(19) United States
(12) Patent Application Publication
(10) Pub. No.: US 2015/0000264 A1
(43) Pub. Date: Jan. 1, 2015

(54) 100% CONVERSION OF THERMAL ENERGY TO MECHANICAL ENERGY USING SMA HEAT ENGINES

(71) Applicants: DYNALLOY, INC., Tustin, CA (US); GM GLOBAL TECHNOLOGY OPERATIONS LLC, Detroit, MI (US)

(72) Inventors: Alan L. Browne, Grosse Pointe, MI (US); Nancy L. Johnson, Northville, MI (US); James Holbrook Brown, Costa Mesa, CA (US); Jeffrey W. Brown, Los Gatos, CA (US); Wayne Brown, Costa Mesa, CA (US)

(73) Assignees: DYNALLOY, INC., Tustin, CA (US); GM GLOBAL TECHNOLOGY OPERATIONS LLC, Detroit, MI (US)

(21) Appl. No.: 13/929,866

(22) Filed: Jun. 28, 2013

(51) Int. Cl. F03G 7/06

(52) U.S. Cl. CPC F03G 7/065
USPC 60/527

(57) ABSTRACT

An energy harvesting system includes a first heat engine, a second heat engine, and an nth heat engine. The heat engines each include at least two rotatable pulleys and a first shape memory alloy (SMA) member. The SMA member is disposed about the at least two rotatable pulleys and defines an SMA pulley ratio. The second heat engine is disposed adjacent the first heat engine. The nth heat engine is disposed such that the second heat engine is disposed between the first heat engine and the nth heat engine. The first SMA member, the second SMA member, and the nth SMA member are configured such that a thermal energy conversion efficiency between the hot temperature region and the cold temperature region is nearly 100%.

### STATEMENT REGARDING FEDERALLY SPONSORED RESEARCH OR DEVELOPMENT

This invention was made with U.S. Government support under ARPA-E Contract number DE-AR0000040, awarded by the Department of Energy. The U.S. Government may have certain rights in this invention.

### TECHNICAL FIELD

The present disclosure relates to the conversion of thermal energy to mechanical energy using SMA heat engines.

### BACKGROUND

Thermal energy may be produced by industrial, assembly, and manufacturing processes. Automobiles, small equipment, and heavy equipment also produce thermal energy. Some of this thermal energy is waste heat, which is heat for which no useful application is found or planned, and is generally a waste by-product. Waste heat may be expelled to the atmosphere. The burning of transport fuels also contributes to waste heat.

### SUMMARY

In an aspect of the disclosure, an energy harvesting system includes a first heat engine, a second heat engine, and an nth heat engine. The first heat engine is configured to be in thermal communication with a hot temperature region and a first intermediate temperature region. The first heat engine includes at least two rotatable pulleys and a first shape memory alloy (SMA) member. The SMA member is disposed about the at least two rotatable pulleys and defines an SMA pulley ratio. One side of the first SMA member is configured to be in thermal communication with the hot temperature region and another side of the first SMA member is configured to be in thermal communication with the first intermediate temperature region. The second heat engine is disposed adjacent the first heat engine and is configured to be in thermal communication with the first intermediate temperature region and a second intermediate temperature region. The second heat engine includes at least two rotatable pulleys and a second SMA member. The second SMA member is disposed about the at least two rotatable pulleys and defines an SMA pulley ratio. One side of the second SMA member is configured to be in thermal communication with the first intermediate temperature region and another side of the second SMA member is configured to be in thermal communication with the second intermediate temperature region. The nth heat engine is disposed such that the second heat engine is disposed between the first heat engine and the nth heat engine. The nth heat engine is configured to be in thermal communication with an nth intermediate temperature region and a cold temperature region. The nth heat engine includes at least two rotatable pulleys and an nth SMA member. The nth SMA member is disposed about the at least two rotatable pulleys and defines an SMA pulley ratio. One side of the nth SMA member is configured to be in thermal communication with the nth intermediate temperature region and another side of the nth SMA member is configured to be in thermal communication with the cold temperature region. The first SMA member, the second SMA member, and the nth SMA member are configured such that a thermal energy conversion efficiency between the hot temperature region and the cold temperature region is nearly 100%.

In another aspect of the disclosure, an energy harvesting system includes a first heat engine, a second heat engine and an nth heat engine. The first heat engine is in thermal communication with a hot temperature region and a first intermediate temperature region. The first heat engine includes at least two rotatable pulleys, a timing cable, and a first SMA element. The timing cable is disposed about a portion of the at least two rotatable pulleys and defines a timing pulley ratio. The first SMA element is disposed about the at least two rotatable pulleys and defines an SMA pulley ratio different than the respective timing pulley ratio. One side of the first SMA member is configured to be in thermal communication with the hot temperature region and another side of the first SMA member is configured to be in thermal communication with the first intermediate temperature region. The second heat engine is disposed adjacent the first heat engine and is configured to be in thermal communication with the first intermediate temperature region and a second intermediate temperature region. The second heat engine includes at least two rotatable pulleys, a timing cable, and a second SMA member. The timing cable is disposed about a portion of the at least two rotatable pulleys and defines a timing pulley ratio. The second SMA member is disposed about the at least two rotatable pulleys and defines an SMA pulley ratio different than the respective timing pulley ratio. One side of the second SMA member is configured to be in thermal communication with the first intermediate temperature region and another side of the second SMA member is configured to be in thermal communication with the second intermediate temperature region. The nth heat engine is disposed such that the second heat engine is disposed between the first heat engine and the nth heat engine. The nth heat engine is configured to be in thermal communication with the nth intermediate temperature region and a cold temperature region. The nth heat engine includes at least two rotatable pulleys, a timing cable, and an nth SMA member. The timing cable is disposed about a portion of the at least two rotatable pulleys and defines a timing pulley ratio. The nth SMA member is disposed about the at least two rotatable pulleys and defines an SMA pulley ratio different than the respective timing pulley ratio. One side is configured to be in thermal communication with the nth intermediate temperature region and another side is configured to be in thermal communication with the cold temperature region. The first SMA member, the second SMA member, and the nth SMA member are configured such that a thermal energy conversion efficiency between the hot temperature region and the cold temperature region is nearly 100%.

In yet another aspect of the disclosure, an energy harvesting system includes a plurality of first heat engines. The plurality of first heat engines are disposed in parallel relationship to one another and are each configured to be in thermal communication with a hot temperature region and a first intermediate temperature region. The first heat engines each include at least two rotatable pulleys and a first SMA member. The first SMA member is disposed about the at least two rotatable pulleys and defines an SMA pulley ratio. One side of each first SMA member is configured to be in thermal communication with the hot temperature region and another side of each first SMA member is configured to be in thermal communication with the first intermediate temperature region. The plurality of first SMA members has a composition configured to provide a phase transformation temperature between the hot temperature region and the first intermediate temperature region such that the energy harvesting system operates at an operating temperature that is constant.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of an energy harvesting system including a plurality of heat engines;

FIG. 2 is a schematic illustration of the energy harvesting system of FIG. 1 having a first through an nth cascade of heat engines;

FIG. 3 is a schematic illustration of a side view of the energy harvesting system of FIG. 1 having a plurality of each of the first through nth heat engines, wherein each of the plurality of first through nth heat engines are cascaded; and

FIG. 4 is a schematic illustration of a side view of the energy harvesting system of FIG. 1 having a plurality of first heat engines arranged in parallel relationship to one another.

### DETAILED DESCRIPTION

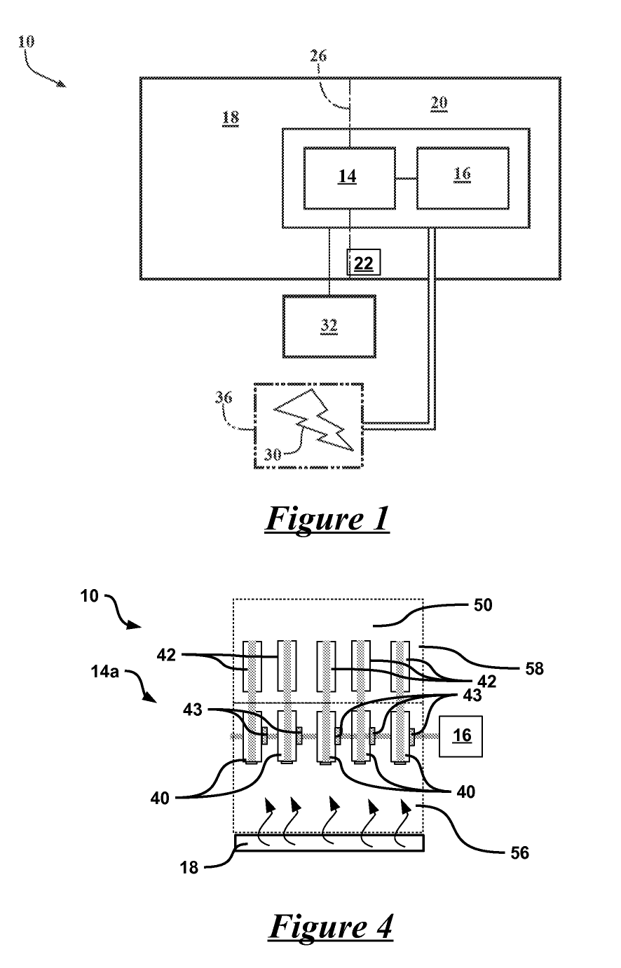

Referring to the drawings, wherein like reference numbers correspond to like or similar components whenever possible throughout the several figures, there is shown in FIG. 1 a heat recovery system or energy harvesting system 10. Features and components shown and described in other figures may be incorporated and used with those shown in FIG. 1. The energy harvesting system 10 shown includes a plurality of heat engines 14 and at least one driven component 16.

The energy harvesting system 10 is disposed in thermal communication with a hot temperature region 18 and a cold temperature region 20. The hot temperature region 18 has a first temperature and may be in heat transfer communication with a heat source, such as waste heat, may be a region in which heat is generated, and/or may represent any region of relatively warm temperature to contribute to operation of the heat engine 14, as described herein. The cold temperature region 20 has a second temperature, which is generally lower than the first temperature of the hot temperature region 18. The cold temperature region 20 may be in heat transfer communication with a cooling source, such as a cold fluid, or may represent any region of relatively cool temperature to contribute to operation of the heat engines 14, as described herein. The cold temperature region 20 is configured to be at least 10 degrees Celsius (C.) below the temperature of the hot region such that operation of the heat engines 14 can occur. The designation of the hot temperature region 18 and the cold temperature region 20, or the temperatures associated therewith as either “first” or “second” is arbitrary and is not limiting.

The heat engines 14, as described herein, are configured to convert thermal energy from the temperature differential between the hot temperature region 18 and the cold temperature region 20 into mechanical energy. The driven components 16 of the energy harvesting system 10 may be configured to be driven by the mechanical energy or power generated from the conversion of thermal energy to mechanical energy within the heat engine 14.

The driven component 16 may be a mechanical device, such as, without limitation: a generator, a fan, a clutch, a blower, a pump, a compressor, and combinations thereof. It should be appreciated that the driven component 16 is not limited to these devices, as any other device known to those skilled in the art may also be used. The driven component 16 may be operatively connected to the heat engine 14 such that the driven component 16 is driven by the heat engine 14.

More specifically, the driven component 16 may be part of an existing system, such as a heating or cooling system and the like. Driving the driven component 16 with mechanical energy provided by the heat engine 14 may also allow an associated existing system within the energy harvesting system 10 to be decreased in size and/or capacity or eliminated entirely.

Additionally, the mechanical energy produced by the energy harvesting system 10 may be stored for later use e.g., a flywheel for kinetic energy, a battery for electrical energy, and the like, or utilized as an auxiliary energy supply. In vehicles or power production facilities, the energy harvesting system 10 increases the overall efficiency of the vehicle or production facility by converting what may have been waste thermal energy into energy for current or later use.

The driven component 16 may be a generator or an electric machine (which may be referred to as a motor/generator) configured to convert the mechanical energy from the heat engine 14 into electricity 30 (as schematically shown in FIG. 1). Alternatively, the driven component 16 may be attached to, or in communication with, a generator. The driven component 16 may be any suitable device configured to convert mechanical energy to electricity 30. For example, the driven component 16 may be an electric machine that converts mechanical energy to electricity 30 using electromagnetic induction. The driven component 16 may include a rotor (not shown) that rotates with respect to a stator (not shown) to generate electricity 30. The electricity 30 generated by the driven component 16 may then be used to assist in powering one or more electric systems or may be stored in an energy storage device.

The hot temperature region 18 and the cold temperature region 20 may be sufficiently spaced from one another to maintain the temperature differential between the two, or may be separated by a sufficient heat exchange barrier 26, including, without limitation: a heat shield, a Peltier device, or an insulating barrier. The heat exchange barrier 26 may be employed to separate each heat engine 14 into the respective hot temperature region 18 and the respective cold temperature region 20 such that a desired temperature differential between the hot temperature region 18 and the cold temperature region 20 is achieved. When the heat exchange barrier 26 disposed between the hot temperature region 18 and the cold temperature region 20 is a Peltier device, such as a thermoelectric heat pump, the heat exchange barrier 26 is configured to generate heat on one side of the barrier 26 and to cool on an opposing side of the barrier 26.

The hot temperature region 18 and the cold temperature region 20 of the energy harvesting system 10 may be filled with, for example and without limitation: gas, liquid, loosely packed granular material, or combinations thereof. Alternatively, the hot temperature region 18 and the cold temperature region 20 may represent contact zones or contact elements configured for conductive heat transfer with the heat engine 14.

Each heat engine utilizes a hot temperature side 56 and a cold temperature side 58. As explained in more detail below, it should be appreciated that what might be a hot temperature side 56 for one or more heat engines 14, may be the cold temperature side 58 for the next heat engine 14. Also, in one or more heat engines, the hot temperature side 56 may correspond to the hot temperature region 18 and the cold temperature side 58 may correspond to the cold temperature region 20. The heat engines 14 are configured to utilize temperature differentials between the respective hot temperature sides 56 and the respective cold temperature sides 58 in the energy harvesting system 10 in areas such as, without limitation: vehicular heat and waste heat, power generation heat and waste heat, industrial waste heat, computer server farms, pipeline pumping stations, geothermal heating and cooling sources, solar heat and waste heat, and combinations thereof. It should be appreciated that the energy harvesting system 10 may be configured to utilize temperature differentials in numerous other areas and industries.

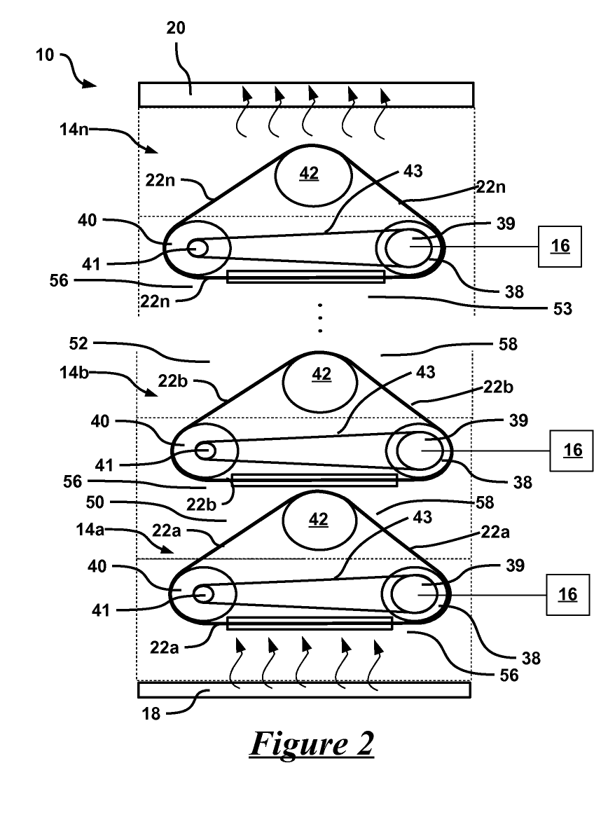

Referring now to FIG. 2, and with continued reference to FIG. 1, there is shown a more-detailed schematic view of the energy harvesting system 10, shown in FIG. 1. Other types and configurations of heat engines may be used with the energy harvesting system 10.

The heat engines 14 of the energy harvesting system 10 each include at least one shape memory alloy (SMA) member 22, as shown in FIG. 1. Referring to FIG. 2, a plurality of SMA members 22a, 22b, 22n are each operatively disposed in, or in heat-exchange communication with, the respective hot temperature side 56 and the cold temperature side 58. In the configuration shown, in one heat engine 14a, the hot temperature sides 56 is adjacent the hot temperature region 18, proximate a heat exhaust pipe and the cold temperature side 58 may be placed adjacent the hot temperature side 56 of another heat engines 14b, or placed in ambient air or in the path of moving, relatively cool, air from fans or blowers. For purposes of clarity, the heat engines 14a, 14b, 14n will be referred to as heat engine 14, and SMA members 22a, 22b, 22n will be referred to as SMA member 22, unless specifically identified.

Referring to FIG. 2, each heat engine 14 also includes a first member or first pulley 38 and a second member or second pulley 40. The heat engine 14 also includes an idler pulley 42, located so as to add travel to the path of the SMA member 22 and which may be configured to variably add tension (or take up slack) to the SMA member 22. In some configurations of the heat engine 14, the idler pulley 42 may not be included.

The SMA member 22 forms a loop around the first pulley 38, the second pulley 40, and the idler pulley 42. As used herein, one loop refers to circumscribing the whole rotational path of the SMA member 22 around the heat engine 14.

In this configuration, the first pulley 38 and the second pulley 40 are disposed between the hot temperature side 56 and the cold temperature side 58. However, the heat engine may be configured with the first pulley 38 operatively disposed in the hot temperature side 56 and the second pulley 40 operatively disposed in the cold temperature side 58, or the reverse. The idler pulley 42 may likewise be disposed in either the hot temperature side 56 or the cold temperature side 58.

Each heat engine 14 further includes two timing members, a first timing pulley 39 and a second timing pulley 41, which are fixed to the first pulley 38 and the second pulley 40, respectively. The first timing pulley 39 and the second timing pulley 41 through the interconnecting SMA member 22 and timing chain 43 provide a mechanical coupling between the first pulley 38 and the second pulley 40 (the two drive pulleys) such that rotation of either drive pulley ensures the rotation of the other in the same direction.

The first timing pulley 39 and the second timing pulley 41 are linked by a timing chain or timing belt 43. Alternatively, a timing mechanism such as sprockets linked with a chain or meshed gears may also be used to provide a mechanical coupling between the first pulley 38 and the second pulley 40. Inclusion of the mechanical coupling provided by the timing chain 43 (in addition to the SMA member 22) between the first pulley 38 and the second pulley 40, means that the heat engine 14 may be referred to as a synchronized heat engine.

The SMA member 22 is disposed about a portion of the first pulley 38 at a first radial distance and about a portion of the second pulley 40 at a second radial distance, the first and second radial distances defining an SMA pulley ratio. The timing belt 43 is disposed about the first timing pulley 39 at a third radial distance and about a portion of second timing pulley 41 at a fourth radial distance, the third and fourth radial distances defining a timing pulley ratio. The SMA pulley ratio is different from the timing pulley ratio.

In the embodiment shown in FIG. 2, the first timing pulley 39 is larger in diameter than the second timing pulley 41. The difference in diameter alters the reactive torque or moment arm provided by the respectively pulley members. Different moment arms about the pulleys cause a resultant torque to be generated from the contraction forces, as explained herein, along the SMA member 22 adjacent the hot temperature region 18.

The heat engines 14 are configured to convert thermal energy to mechanical energy and, with the help of the driven component 16, convert mechanical energy to electrical energy. More specifically, the energy harvesting system 10 utilizes a temperature differential between the hot temperature region 18 and the cold temperature region 20 to generate mechanical and/or electrical energy via the SMA member 22, as explained in more detail below. The mechanical and electrical energy created from available thermal energy may be used or stored, as opposed to allowing the thermal energy to dissipate. The SMA member 22 is configured such that a conversion of heat between the hot temperature region 18 and the cold temperature region 20 is at least equal to the sum of the maximum heat flux into, and maximum heat generation rate within, the hot temperature region 18.

The SMA member 22 is disposed in thermal contact, or heat-exchange communication, with each of the hot temperature side 56 and the cold temperature side 58. The SMA member 22 of the heat engine 14 has a crystallographic phase changeable between austenite and martensite in response to exposure to the first and second temperatures of the hot temperature region 18 and the cold temperature region 20.

As used herein, the terminology “SMA” (SMA) refers to alloys that exhibit a shape memory effect. That is, the SMA member 22 may undergo a solid state, crystallographic phase change via a shift between a martensite phase, i.e., “martensite”, and an austenite phase, i.e., “austenite.” The Martensite phase is a relatively soft and easily deformable phase of the shape memory alloys, which generally exists at lower temperatures. The Austenite phase, the stronger phase of shape memory alloys, occurs at higher temperatures. The temperature at which the shape memory alloy remembers its high temperature form, referred to as the phase transformation temperature, can be adjusted by applying stress and other methods. Accordingly, a temperature difference between the Austenite phase and the Martensite phase may be the phase transformation delta T. Alternatively stated, the SMA member 22 may undergo a displacive transformation rather than a diffusional transformation to shift between martensite and austenite. A displacive transformation is a structural change that occurs by the coordinated movement of atoms (or groups of atoms) relative to their neighbors. In general, the martensite phase refers to the comparatively lower-temperature phase and is often more deformable—i.e., Young's modulus is approximately 2.5 times lower—than the comparatively higher-temperature austenite phase.

The temperature at which the SMA member 22 begins to change from the austenite phase to the martensite phase is known as the martensite start temperature, Mₛ. The temperature at which the SMA member 22 completes the change from the austenite phase to the martensite phase is known as the martensite finish temperature, M_{f}. Similarly, as the SMA member 22 is heated, the temperature at which the SMA member 22 begins to change from the martensite phase to the austenite phase is known as the austenite start temperature, Aₛ. The temperature at which the SMA member 22 completes the change from the martensite phase to the austenite phase is known as the austenite finish temperature, A_{f}.

Therefore, the SMA member 22 may be characterized by a cold state, i.e., when a temperature of the SMA member 22 is below the martensite finish temperature M_{f} of the SMA member 22. Likewise, the SMA member 22 may also be characterized by a hot state, i.e., when the temperature of the SMA member 22 is above the austenite finish temperature A_{f} of the SMA member 22.

In operation, the SMA member 22 that is pre-strained or subjected to tensile stress can change dimension upon changing crystallographic phase to thereby convert thermal energy to mechanical energy. That is, the SMA member 22 may change crystallographic phase from martensite to austenite and thereby dimensionally contract if pseudoplastically pre-strained so as to convert thermal energy to mechanical energy. Conversely, the SMA member 22 may change crystallographic phase from austenite to martensite and if under stress thereby dimensionally expand and be stretched.

The difference in stiffness, and thus in stress, in the austenite and martensite sections of the SMA member 22 coupled with the pulley ratio between the first timing pulley 39 and the second timing pulley 41 produces net torque from thermal energy. The net torque causes the SMA member 22 to rotate and create kinetic energy in the heat engine 14, which the driven member 16 may then convert into electrical energy or otherwise utilize.

Pseudoplastically pre-strained refers to stretching of the SMA member 22 while in the martensite phase so that the strain exhibited by the SMA member 22 under that loading condition is not fully recovered when unloaded, where purely elastic strain would be fully recovered. In the case of the SMA member 22, it is possible to load the material such that the elastic strain limit is surpassed and deformation takes place in the martensitic crystal structure of the material prior to exceeding the true plastic strain limit of the material. Strain of this type, between those two limits, is pseudoplastic strain, called such because upon unloading it appears to have plastically deformed. However, when heated to the point that the SMA member 22 transforms to its austenite phase, that strain can be recovered, returning the SMA member 22 to the original length observed prior to application of the load.

The SMA member 22 may be stretched before installation into the heat engine 14, such that a nominal length of the SMA member 22 includes recoverable pseudoplastic strain. Alternating between the pseudoplastic deformation state (relatively long length) and the fully-recovered austenite phase (relatively short length) provides the motion used for actuating or driving the heat engine 14. Without pre-stretching the SMA member 22, little deformation would be seen during phase transformation.

The SMA member 22 may change both modulus and dimension upon changing crystallographic phase to thereby convert thermal energy to mechanical energy. More specifically, the SMA member 22, if pseudoplastically pre-strained, may dimensionally contract upon changing crystallographic phase from martensite to austenite and may dimensionally expand, if under tensile stress, upon changing crystallographic phase from austenite to martensite to thereby convert thermal energy to mechanical energy. Therefore, when a temperature differential exists between the first temperature of the hot temperature side 56 and the second temperature of the cold temperature side 58, i.e., when the hot temperature side 56 and the cold temperature side 58 are not in thermal equilibrium, respective localized regions of the SMA member 22 disposed within the hot temperature region 18 and the cold temperature side 58 may respectively dimensionally expand and contract upon changing crystallographic phase between martensite and austenite.

The SMA member 22 may have any suitable composition. In particular, the SMA member 22 may include an element selected from the group including, without limitation: cobalt, nickel, titanium, indium, manganese, iron, palladium, zinc, copper, silver, gold, cadmium, tin, silicon, platinum, gallium, and combinations thereof. For example, and without limitation, suitable SMAs 22 may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations thereof.

The SMA member 22 can be binary, ternary, or any higher order so long as the SMA member 22 exhibits a shape memory effect, i.e., a change in shape orientation, damping capacity, and the like. The specific SMA member 22 may be selected according to desired operating temperatures of the hot temperature side 56 and the cold temperature side 58, as set forth in more detail below. In one specific example, the SMA member 22 may include nickel and titanium.

As shown in FIG. 1, the energy harvesting system 10 may include a control system 32 that is configured to monitor the first and second temperature of the fluid in the hot temperature region 18 and the cold temperature region 20, respectively. The control system 32 may be operatively connected to any of the components of the energy harvesting system 10.

The control system 32 may be a computer that electronically communicates with one or more controls and/or sensors of the energy harvesting system 10. For example, the control system 32 may communicate with temperature sensors within the hot temperature region 18 and the cold temperature region 20, a speed regulator of the driven component 16, fluid flow sensors, and/or meters configured for monitoring electricity 30 generation of the driven component 16.

Additionally, the control system 32 may be configured to control the harvesting of energy under predetermined conditions of the energy harvesting system 10, e.g., after the energy harvesting system 10 has operated for a sufficient period of time such that a temperature differential between the hot temperature region 18 and the cold temperature region 20 is at a sufficient, or an optimal, differential. Other predetermined conditions of the energy harvesting system 10 may also be used. The control system 32 may also be configured to provide an option to manually override the heat engine 14 and allow the energy harvesting system 10 to effectively be turned off, such as when the thermal energy supplying the hot temperature region 18 is needed elsewhere and should not be converted into other forms of energy by the heat engine 14. A clutch (not shown) may also be controlled by the control system 32 to selectively disengage the heat engine 14 from the driven component 16.

The electricity 30 from the driven component 16 may be communicated to a storage device 36, which may be, without limitation, a battery, battery pack, or another energy storage device. The storage device 36 may be located proximate to, but physically separate from, the energy harvesting system 10.

For any of the examples discussed herein, the energy harvesting system 10 includes a plurality of heat engines 14 and/or a plurality of driven components 16. Likewise, the energy harvesting system 10 may be coupled or operated in conjunction with additional energy harvesting systems 10, where each energy harvesting system 10 includes a plurality of heat engines 14 and at least one driven component 16. The use of multiple energy harvesting systems 10 may take advantage of multiple regions of temperature differentials.

Referring again to FIG. 2, for each heat engine 14, the first pulley 38 and the second pulley 40 may also include, without limitation: a gear, a one-way clutch, or a spring. A one-way clutch may be configured to allow rotation of the first pulley 38 and the second pulley 40 in only one direction.

The first pulley 38, the second pulley 40, or the idler pulley 42 is operatively connected to the driven component 16 such that rotation—as a result of the dimensional change of the SMA member 22—drives the driven component 16. Furthermore, each of the pulley members may be connected to the driven component 16, or may feed into a transmission or gear system before transferring mechanical energy to the driven member 16. Although three rotational members 38, 40, 42 are shown in FIG. 2, it should be appreciated that more or fewer members may be used.

As described herein, the SMA member 22 may be embedded within a belt or cable. Furthermore, the SMA member 22 may be configured as a longitudinally extending SMA wire that is embedded within the belt such that the belt longitudinally expands and contracts as a function of the associated SMA member 22 as it is expanding and contracting. Additionally, or alternatively, the SMA member 22 may be configured as one or more helical springs that may be embedded within the belt. The SMA member 22 may be a wire that has any desired cross-sectional shape, i.e., round, rectangular, octagonal, ribbon, or any other shape known to those skilled in the art; and the term wire may refer to SMA of any shape. Additionally, the belt may be at least partially formed from a resilient material. For example, the resilient material may be an elastomer, a polymer, combinations thereof, and the like. The belt may be formed as a continuous loop, or as an elongated strip, which is then joined at its ends to form a loop.

The SMA wire can also be flattened into ribbons of arbitrary aspect ratios. Ribbons have better lateral heat transfer characteristics than wire of the same cross-sectional area. When wound around a flat pulley, ribbons have higher friction than straight wire, due to the added contact area. While high aspect-ratio ribbons may have fatigue problems, ribbon with a 3:1 cross-sectional aspect ratio has similar fatigue properties to that of straight wire. However, ribbon having a 3:1 cross-sectional aspect ratio may increase heat transfer by twenty percent. Ribbon-type SMA working members may be, for example and without limitation: straight, wavy or corrugated, with cutouts or holes, or with hanging chads (active or nonactive).

In operation of the heat engines 14 shown in FIG. 2, a localized region of the SMA member 22 may be disposed within, or directly adjacent to, the hot temperature side 56 such that the first temperature causes that corresponding localized region of the SMA member 22 to longitudinally contract as a function of the first temperature of the hot temperature side 56. Similarly, another localized region of the SMA member 22 may be similarly disposed within, or adjacent to, the cold temperature side 58 such that the second temperature causes that localized region of the SMA member 22 to longitudinally expand as a function of the second temperature of the cold temperature side 58.

For example, if the first temperature of the hot temperature side 56 is at or above the hot state, the associated localized region of the SMA member 22 will longitudinally contract as a result of a phase change of the SMA member 22 from the martensite phase to the austenite phase. Similarly, if the second temperature of the cold temperature region 20 is below the cold state, the associated localized region of the SMA member 22 will longitudinally expand while under tension as a result of a phase change of the SMA member 22 from the austenite phase to the martensite phase.

The SMA member 22 is continuously looped about the first pulley 38, the second pulley 40, and the idler pulley 40 such that motion imparted from the SMA member 22 causes rotation of each of the first pulley 38, the second pulley 40, and the idler pulley 42. The longitudinal expansion and/or contraction of the localized regions of the SMA member 22 impart motion from the SMA member 22 to the first pulley 38 and the second pulley 40 to move or drive the driven component 16. The localized regions are those portions of the SMA member 22 that are in the respective hot temperature side 56 and the cold temperature side 58 at any given moment.

As shown in the heat engine 14 of FIG. 2, when the SMA member 22 contracts after being heated by the hot temperature side 56, the first timing pulley 39 provides a larger reactive torque than the second timing pulley 41. Therefore, the contraction of the SMA member 22 between the first pulley 38 and the second pulley 40 (which rotate in common with the first timing pulley 39 and the second timing pulley 41, respectively) causes the SMA member 22 to move toward the first pulley 38. As the heat engine 14 enters dynamic operation, the SMA member 22, the first pulley 38, and the second pulley 40 rotate counterclockwise.

The energy harvesting system 10 does not require liquid baths for the hot temperature region 18 and the cold temperature region 20. Therefore, the heat engine 14a, 14b, 14n does not require significant portions of the SMA member 22 to be submersed in liquids.

In a heat engine dominated by bending, such as a thermobile-type heat engine, output can be increased by constructing an I-beam with SMA elements. In the I-beam, the SMA elements are located at the flanges and a non-active material, such as rubber, is located in the web. Similarly, box beams can be constructed from SMA elements. In box beams, the SMA material is moved away from the neutral axis in the bending dominated heat engine. This increases utilization of the SMA, and thus increases the power output capability of the bending type heat engine.

Referring again to FIG. 2, and with continued reference to FIG. 1, the energy harvesting system 10 is shown as having a plurality of heat engines 14, i.e., a first heat engine 14a, a second heat engine 14b, an nth heat engine 14n. The heat engines 14 are arranged in a cascading or chained fashion with the cold temperature side 58 of one heat engine acting as the hot temperature side 56 of an adjacent heat engine 14a, 14b, 14n.

With continued reference to FIG. 2, the hot temperature region 18 may contain, for example, hot fluids. Similarly, the cold temperature region 20 may contain cold fluids. In this configuration the total temperature difference—and, therefore, the total thermal energy available—is split or divided into several smaller temperature differential windows. However, as discussed previously, the temperature of the cold temperature region is at least 10 degrees C. above ambient temperature, such that operation of the heat engines 14 can occur.

In the configuration shown, the highest temperature heat engine, denoted as the first heat engine 14a, or a hot heat engine, would take the heat into its hot temperature side 56 directly from the hot temperature region 18, and then output its cold temperature side 58 into a first intermediate temperature region 50, i.e., the hot temperature side 56 of the next engine 14b, denoted as the second heat engine 14b. Therefore, after conversion to mechanical energy, the remaining thermal energy is expelled from the cold temperature side 58 of the first heat engine 14a and is cascaded to the second heat engine 14b. Next, the second heat engine 14b would take the heat into its hot temperature side 56 directly from the first intermediate temperature region 50 and then output its cold temperature side 58 into a second intermediate temperature region 52. This cascading continues until, eventually, the nth heat engine 14n expels any remaining heat to the cold temperature region 20. The nth heat engine 14n is the last heat engine in the series of heat engines 14a, 14b, 14n that has a hot side temperature, sufficiently greater than that of the cold region 20, so as to cause the heat engine to function/rotate, i.e., a difference of at least 10 degrees Celsius. There may be any desired number of heat engines that are arranged in cascading relationship between the first heat engine 14a and the nth heat engine 14n so as to convert as much thermal energy to mechanical energy as possible. More specifically, a number of cascading heat engines 14 may be selected as a function of an efficiency of each of the heat engines 14. The efficiency may be at least 2.0% and more preferably 2.5%. By way of a non-limiting example, if the efficiency of each of the heat engines 14 is 2.5%, then the number of cascading heat engines, i.e., the nth heat engine 14n, is at least 40. This way, while only 2.5% of the thermal energy in the first heat engine 14a will be converted to mechanical energy to power the driven component 16, the remaining 97.5% of thermal energy, given off as waste heat via the cold temperature side 58 of the first heat engine 14a, is further converted to mechanical energy by each of the remaining, cascading heat engines 14b to 14n to eventually convert nearly 100% of the thermal energy to mechanical energy. It should be appreciated that the conversion of the thermal energy to mechanical energy is nearly 100%, as limited by frictional losses in the mechanical system.

The cold sink (or cold side) of the first heat engine 14a acts as the heat source for the second heat engine 14b. Similarly, the cold side of the second heat engine 14b ultimately acts as the heat source for the nth heat engine 14n. An nth SMA member is in communication with, and ultimately takes heat from, the cold temperature side 58 of the second heat engine 14b as its heat source. The hot temperature side 56 of the nth SMA member undergoes its phase change at a lower temperature than, and draws heat from the cold temperature side 58 of the second SMA member.

As the lowest temperature engine in the configuration shown in FIG. 2, a cold temperature side 58 of the nth heat engine eventually interacts directly with the cold temperature region 20. While each of the heat engines 14a, 14b, 14n interacts with different temperature hot and cold temperature regions 18, 20, the temperature differential between the respective hot and cold sides of each heat engine 14a, 14b, 14n may be similar to one another.

There may be any number of heat engines 14 taking heat from an adjacent heat engine 14 and expelling heat to a next adjacent heat engine 14 so as to convert 100% of the thermal energy between the hot temperature region 18 and the cold temperature region 20 to mechanical energy.

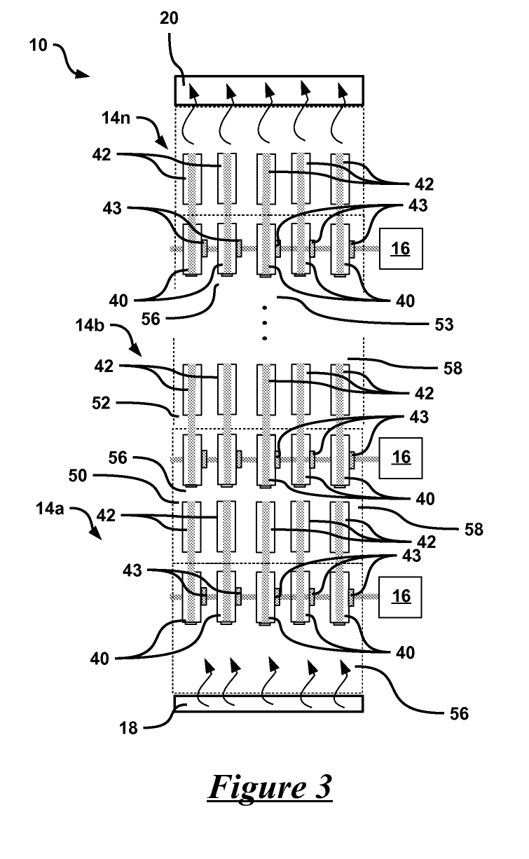

Referring now to FIGS. 3 and 4, the energy harvesting device 10 may be configured such that the first heat engine 14a is a plurality of first heat engines 14a that are disposed in parallel relationship to one another such that one side of each of the first SMA members 22a is configured to be in thermal communication with the hot temperature region 18 and the other side of each of the first SMA members 22a is configured to be in thermal communication with the first intermediate temperature region 50. Likewise, with specific reference to FIG. 3, the second heat engine 14b is a plurality of second heat engines 14b that are disposed in parallel relationship to one another such that one side of each of the second SMA members 22b is configured to be in thermal communication with the first intermediate temperature 50 region and the other side of each of the second SMA members 22b is configured to be in thermal communication with the second intermediate temperature region 52. The heat engines 14a, 14b, 14n are cascaded until, eventually, the nth heat engine is a plurality of nth heat engines 14n that are disposed in adjacent relationship to one another. As such, one side of each of the nth SMA members 22n is configured to be in thermal communication with the nth intermediate temperature region 53 and the other side of each of the nth SMA members 22n is configured to be in thermal communication with the cold temperature region 20. The combination of the cascading heat engines 14a, 14b, 14n are configured so as to convert nearly 100% of the thermal energy between the hot temperature region 18 and the cold temperature region 20 to mechanical energy. As described above, the conversion of the thermal energy to mechanical energy is nearly 100%, as limited by frictional losses in the mechanical system.

In an alternate embodiment, with reference to FIG. 4, the energy harvesting system 10 may be configured to limit the operating temperature or otherwise maintain the operating temperature at a temperature that is less than or equal to a desired maximum temperature for the hot temperature region 18 where there is heat input and/or waste heat generation of sufficient magnitude to otherwise create an undesirable high temperature within the hot temperature region 18. The plurality of first heat engines 14a are disposed in parallel relationship to one another such that one side of each of the first SMA members 22a is configured to be in thermal communication with the hot temperature region 18 and the other side of each of the first SMA members 22a is configured to be in thermal communication with the first intermediate temperature region 50. As such, the SMA member 22 should be chosen to have a composition with a phase transformation delta T and values for the austenite start temperature Aₛ, the austenite finish temperature A_{f}, the martensite start temperature Mₛ, and the martensite finish temperature M_{f} that are consistent with producing heat engine operation, and thus heat exchange, i.e., heat to kinetic energy, and heat transport, sufficient to produce no net increase in system temperature when the hot temperature region 18 reaches a critical or desirable level.

Additionally, the geometric form and quantity of SMA members 22 within each heat engine 14 are selected to produce a sufficiently high heat removal rate from the hot temperature region 18, that matches a maximum waste heat generation rate within and/or heat transfer rate into the hot temperature region 18. Contributing to this heat removal rate are the conversion of the heat by the heat engine 14 to produce a mechanical energy output, and a latent heat of transformation and the specific heat property of the SMA. As such, the operating temperature is not exceeded within the hot temperature region 18.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An energy harvesting system comprising:
a first heat engine configured to be in thermal communication with a hot temperature region and a first intermediate temperature region, wherein the first heat engine includes:
at least two first rotatable pulleys;
a first shape memory alloy (SMA) member disposed about the at least two first rotatable pulleys and defining an SMA pulley ratio; and
wherein one side of the first SMA member is configured to be in thermal communication with the hot temperature region and another side of the first SMA member is configured to be in thermal communication with the first intermediate temperature region;
a second heat engine disposed adjacent the first heat engine and configured to be in thermal communication with the first intermediate temperature region and a second intermediate temperature region, the second heat engine including:
at least two second rotatable pulleys;
a second SMA member disposed about the at least two second rotatable pulleys and defining an SMA pulley ratio; and
wherein one side of the second SMA member is configured to be in thermal communication with the first intermediate temperature region and another side of the second SMA member is configured to be in thermal communication with the second intermediate temperature region; and
an nth heat engine disposed such that the second heat engine is disposed between the first heat engine and the nth heat engine, wherein the nth heat engine is configured to be in thermal communication with an nth intermediate temperature region and a cold temperature region, the nth heat engine including:
at least two nth rotatable pulleys;
an nth SMA member disposed about the at least two nth rotatable pulleys and defining an SMA pulley ratio;
wherein one side of the nth SMA member is configured to be in thermal communication with the nth intermediate temperature region and another side of the nth SMA member is configured to be in thermal communication with the cold temperature region;
wherein the first SMA member, the second SMA member, and the nth SMA member are configured such that a thermal energy conversion efficiency between the hot temperature region and the cold temperature region is nearly 100%.

2. The energy harvesting system of claim 1, wherein a phase transformation temperature differential between the one side and the other side of each of the first heat engine, the second heat engine, and the nth heat engine is configured such that a thermal energy conversion efficiency between the hot temperature region and the cold temperature region is nearly 100%.

3. The energy harvesting system of claim 2, wherein a temperature of the cold temperature region is configured to be at least ten degrees Celsius above ambient temperature.

4. The energy harvesting system of claim 1, wherein the nth heat engine is at least a fortieth heat engine.

5. The energy harvesting system of claim 1, wherein the first heat engine is a plurality of first heat engines disposed in adjacent relationship to one another such that one side of each of the first SMA members is configured to be in thermal communication with the hot temperature region and the other side of each of the first SMA members is configured to be in thermal communication with the first intermediate temperature region;
wherein the second heat engine is a plurality of second heat engines disposed in adjacent relationship to one another such that one side of each of the second SMA members is configured to be in thermal communication with the first intermediate temperature region and the other side of each of the second SMA members is configured to be in thermal communication with the second intermediate temperature region; and
wherein the nth heat engine is a plurality of nth heat engines disposed in adjacent relationship to one another such that one side of each of the nth SMA members is configured to be in thermal communication with the nth intermediate temperature region and the other side of each of the nth SMA members is configured to be in thermal communication with the cold temperature region.

6. The energy harvesting system of claim 5, wherein each of the first SMA member, the second SMA member, and the nth SMA member is configured to have respective efficiency of at least 2.5%.

7. The energy harvesting system of claim 1, wherein each of the SMA members is configured such that a conversion of heat between the hot temperature region and the cold temperature region of the combination of heat engines is at least equal to a sum of the maximum heat flux into, and maximum heat generation rate within, the hot temperature region.

8. The energy harvesting system of claim 7, wherein at least one of the rotatable pulleys of at least one of the heat engines is configured to be operatively connected to a driven component such that heat is converted to mechanical energy to operate the driven component.

9. An energy harvesting system comprising:
a first heat engine in thermal communication with a hot temperature region and a first intermediate temperature region, the first heat engine including:
at least two first rotatable pulleys;
a timing cable disposed about a portion of the at least two first rotatable pulleys and defining a timing pulley ratio;
a first shape memory alloy (SMA) element disposed about the at least two first rotatable pulleys and defining an SMA pulley ratio different than the respective timing pulley ratio; and
wherein one side of the first SMA member is configured to be in thermal communication with the hot temperature region and another side of the first SMA member is configured to be in thermal communication with the first intermediate temperature region;
a second heat engine disposed adjacent the first heat engine and configured to be in thermal communication with the first intermediate temperature region and a second intermediate temperature region, the second heat engine including:
at least two second rotatable pulleys;
a timing cable disposed about a portion of the at least two second rotatable pulleys and defining a timing pulley ratio;
a second SMA member disposed about the at least two rotatable pulleys and defining an SMA pulley ratio different than the respective timing pulley ratio; and
wherein one side of the second SMA member is configured to be in thermal communication with the first intermediate temperature region and another side of the second SMA member is configured to be in thermal communication with the second intermediate temperature region; and
an nth heat engine disposed such that the second heat engine is disposed between the first heat engine and the nth heat engine, wherein the nth heat engine is configured to be in thermal communication with the nth intermediate temperature region and a cold temperature region, the nth heat engine including:
at least two nth rotatable pulleys;
a timing cable disposed about a portion of the at least two nth rotatable pulleys and defining a timing pulley ratio;
an nth SMA member disposed about the at least two nth rotatable pulleys and defining an SMA pulley ratio different than the respective timing pulley ratio;
wherein one side is configured to be in thermal communication with the nth intermediate temperature region and another side is configured to be in thermal communication with the cold temperature region;
wherein the first SMA member, the second SMA member, and the nth SMA member are configured such that a thermal energy conversion efficiency between the hot temperature region and the cold temperature region is nearly 100%.

10. The energy harvesting system of claim 9, wherein a phase transformation temperature differential between the one side and the other side of each of the first heat engine, the second heat engine, and the nth heat engine is configured such that a thermal energy conversion efficiency between the hot temperature region and the cold temperature region is nearly 100%.

11. The energy harvesting system of claim 10, wherein a temperature of the nth temperature region is configured to be at least ten degrees Celsius above ambient temperature.

12. The energy harvesting system of claim 9, wherein the nth heat engine is at least a fortieth heat engine.

13. The energy harvesting system of claim 9, wherein the first heat engine is a plurality of first heat engines disposed in adjacent relationship to one another such that the one side of each of the first SMA members is configured to be in thermal communication with the hot temperature region and the other side of each of the first SMA members is configured to be in thermal communication with the first intermediate temperature region;
wherein the second heat engine is a plurality of second heat engines disposed in adjacent relationship to one another such that the one side of each of the second SMA members is configured to be in thermal communication with the first intermediate temperature region and the other side of each of the second SMA members is configured to be in thermal communication with the second intermediate temperature region; and
wherein the nth heat engine is a plurality of nth heat engines disposed in adjacent relationship to one another such that the one side of each of the nth SMA members is configured to be in thermal communication with the nth intermediate temperature region and the other side of each of the nth SMA members is configured to be in thermal communication with the cold temperature region.

14. The energy harvesting system of claim 13, wherein each of the first SMA member, the second SMA member, and the nth SMA member is configured to have respective efficiency of at least 2.0%.

15. The energy harvesting system of claim 9, wherein each of the SMA members is configured such that a conversion of heat between the hot temperature region and the cold temperature region of the combination of heat engines is at least equal to a sum of the heat flux into, and maximum heat generation rate within, the hot temperature region.

16. The energy harvesting system of claim 15, wherein at least one of the rotatable pulleys of at least one of the heat engines is configured to be operatively connected to a driven component such that heat is converted to mechanical energy to operate the driven component.

17. An energy harvesting system comprising:
a plurality of first heat engines disposed in parallel relationship to one another, wherein each of the plurality of first heat engines is configured to be in thermal communication with a hot temperature region and a first intermediate temperature region, wherein the first heat engines each include:
at least two first rotatable pulleys;
a first shape memory alloy (SMA) member disposed about the at least two first rotatable pulleys and defining an SMA pulley ratio; and
wherein one side of each of first SMA member is configured to be in thermal communication with the hot temperature region and another side of each first SMA member is configured to be in thermal communication with the first intermediate temperature region;
wherein the first SMA member is each heat engine has a composition configured to provide a phase transformation temperature between the hot temperature region and the first intermediate temperature region such that the energy harvesting system operates at an operating temperature that is less than or equal to a maximum temperature for the hot temperature region.

18. The energy harvesting system of claim 17, wherein a temperature of the cold temperature region is configured to be no greater than ambient temperature.

19. The energy harvesting system of claim 17, further comprising:
a plurality of second heat engines disposed parallel relationship to one another;
wherein each of the plurality of second heat engines is disposed in adjacent relationship to the plurality of first heat engines and each of the plurality of second heat engines is configured to be in thermal communication with the first intermediate temperature region and a second intermediate temperature region, the plurality of second heat engines each including:
at least two second rotatable pulleys;
a second SMA member disposed about the at least two second rotatable pulleys and defining an SMA pulley ratio; and
wherein one side of each second SMA member is configured to be in thermal communication with the first intermediate temperature region and another side of each second SMA member is configured to be in thermal communication with the second intermediate temperature region; and
a plurality of nth heat engines disposed in parallel relationship to one another;
wherein each of the plurality of nth heat engines is disposed such that the plurality of second heat engines is disposed between the plurality of first heat engines and the plurality of nth heat engines, wherein the plurality of nth heat engines is configured to be in thermal communication with an nth intermediate temperature region and a cold temperature region, the plurality of nth heat engines each including:
at least two nth rotatable pulleys;
an nth SMA member disposed about the at least two nth rotatable pulleys and defining an SMA pulley ratio;
wherein one side of the each SMA member is configured to be in thermal communication with the second intermediate temperature region and another side of each nth SMA member is configured to be in thermal communication with the cold temperature region;
wherein the plurality of first SMA members has a composition configured to provide a phase transformation temperature between the hot temperature region and the cold temperature region such that the energy harvesting system operates at an operating temperature that is less than or equal to a maximum temperature for the hot temperature region.

20. The energy harvesting system of claim 17, wherein at least one of the rotatable pulleys of at least one of the plurality of first heat engines is configured to be operatively connected to a driven component such that heat is converted to mechanical energy to operate the driven component
